(19) United States
(12) Patent Application Publication
(10) Pub. No.: US 2014/0200888 A1
(43) Pub. Date: Jul. 17, 2014

(54) System and Method for Generating a Script for a Web Conference

(71) Applicants: Ruwei Liu, Anhui (CN); Jun Hao, Anhui (CN); Bingkui Jia, Anhui (CN); Jinhui Yang, Anhui (CN); Delei Xie, Anhui (CN)

(72) Inventors: Ruwei Liu, Anhui (CN); Jun Hao, Anhui (CN); Bingkui Jia, Anhui (CN); Jinhui Yang, Anhui (CN); Delei Xie, Anhui (CN)

(21) Appl. No.: 13/739,055

(22) Filed: Jan. 11, 2013

(51) Int. Cl. G10L 15/26

(52) U.S. Cl. CPC G10L 15/26
USPC 704/235

(57) ABSTRACT

A system includes an interface operable to detect a plurality of active audio streams in a plurality of multimedia streams, each multimedia stream associated with a particular user. The system further includes a processor operable to generate a text translation of each active audio stream and generate a script comprising the text translation of each active audio stream and an indication of the particular user associated with each active audio stream, the text translations being ordered according to times associated with the respective corresponding active audio stream.

### TECHNICAL FIELD

The present disclosure relates generally to web conferences, and more specifically to generating a script for a web conference.

### BACKGROUND

In previous systems, a user who was not able to attend the web conference or who was otherwise interested in the content of the conference would have to either watch or listen to a recording of the web conference. Alternatively, the user would have to read the text of the conference without any indication of who said each statement and when the statement was said. Each of these choices may be insufficient as they each present difficulties in obtaining the relevant information from the conference in a short amount of time.

### BRIEF DESCRIPTION OF THE DRAWINGS

For a more complete understanding of particular embodiments and their advantages, reference is now made to the following description, taken in conjunction with the accompanying drawings, in which:

FIG. 1 illustrates a system that includes nodes participating in a web conference facilitated by a conference server over a network;

FIG. 2A illustrates an example conference server of the system of FIG. 1 according to particular embodiments of the present disclosure;

FIG. 2B illustrates an example audio table of the conference server of FIG. 2A according to particular embodiments of the present disclosure;

FIG. 2C illustrates an example content table of the conference server of FIG. 2A according to particular embodiments of the present disclosure;

FIG. 2D illustrates an example event table of the conference server of FIG. 2A according to particular embodiments of the present disclosure;

FIG. 2E illustrates an example script of a web conference produced by the conference server of FIG. 2A according to particular embodiments of the present disclosure;

FIG. 3 illustrates and example method for generating a script of a web conference using the conference server of FIG. 1 according to particular embodiments of the present disclosure; and

FIG. 4 illustrates an example architecture of the conference server of FIG. 1 according to particular embodiments of the present disclosure.

### DETAILED DESCRIPTION

### Overview

A system includes an interface operable to detect a plurality of active audio streams in a plurality of multimedia streams, each multimedia stream associated with a particular user. The system further includes a processor operable to generate a text translation of each active audio stream and generate a script comprising the text translation of each active audio stream and an indication of the particular user associated with each active audio stream, the text translations being ordered according to times associated with the respective corresponding active audio stream.

Embodiments of the present disclosure may provide numerous technical advantages. For example, certain embodiments of the present disclosure may allow for the generation of web conference records that are easily accessed and understood at a later time. As another example, certain embodiments may allow for the storage of the web conference records such that they are easily searchable by users that may not have participated in the web conference.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### DESCRIPTION OF EXAMPLE EMBODIMENTS

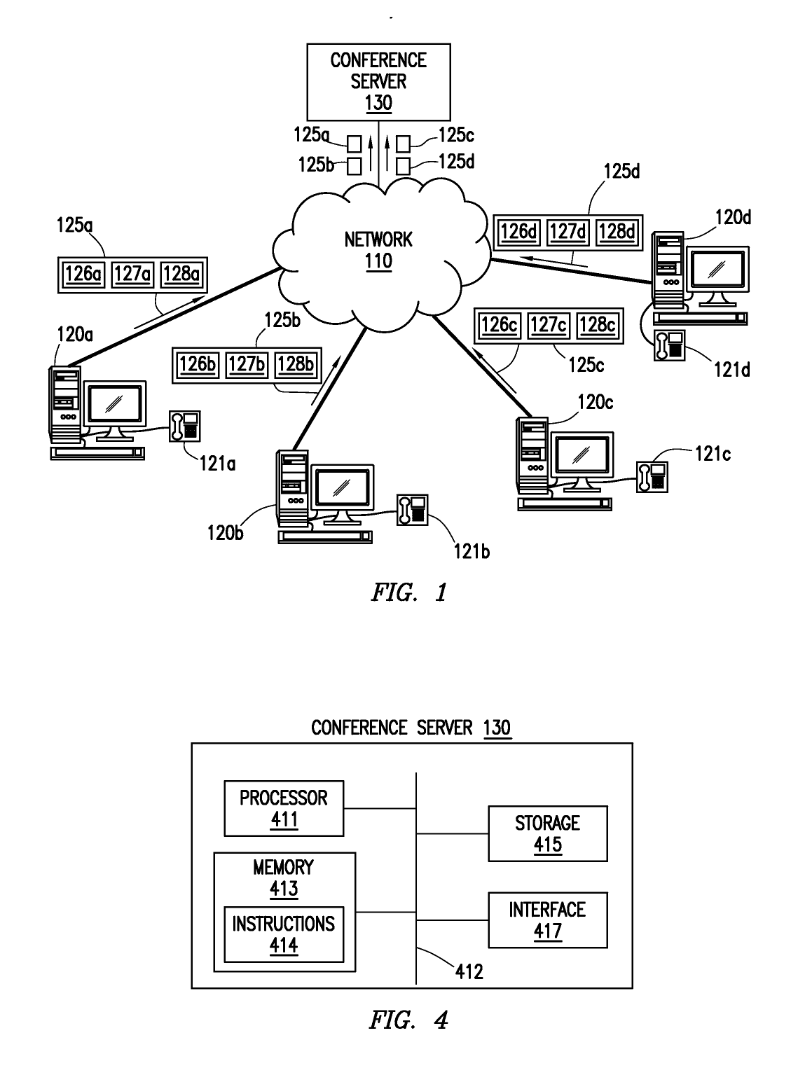

Embodiments of the present disclosure are best understood by referring to FIGS. 1 through 4 of the drawings, like numerals being used for like and corresponding parts of the various drawings.

FIG. 1 illustrates a system 100 that includes nodes 120 participating in a web conference facilitated by conference server 130 over network 110. Nodes 120 may participate in a web conference by logging in to conference server 130, which may facilitate voice communication between nodes 120 and allow each node 120 to share documents, presentations, etc. with the other nodes. In particular embodiments, a telephone device 121 may be associated with each node 120 to facilitate voice communication. In other embodiments, voice communication may be facilitated directly through node 120, such as through a microphone coupled to node 120.

In facilitating a web conference, conference server 130 may receive a multimedia stream 125 from each node 120. The multimedia stream 125 may include an audio stream 126 (e.g. voice audio from the conference participant), content 127 (e.g. documents being shared with other nodes), events 128, and/or other information such as metadata related to audio stream 126, content 127, or events 128. In previous systems, a user who was not able to make the web conference or who was otherwise interested in the content of the conference would have to either watch or listen to a recording of the web conference. Alternatively, the user would have to read the text of the conference without any indication of who said each statement and when the statement was said. Each of these choices may be insufficient as they each present difficulties in obtaining the relevant information from the conference in a short amount of time.

According to particular embodiments of the present disclosure, however, conference server 130 may detect active audio streams of audio streams 126, changes in the content being distributed amongst nodes 120, and/or conference events (e.g. joining/leaving the conference, conference roster updates, initiating voting, initiating question and answer session, etc.) from the received multimedia streams 125. Conference servers 130 may then convert the active audio streams to text using speech-to-text technology and generate a web conference script based on the text. For instance, the script may include the text for each statement made during the web conference and associate each of the statements with the user who made them. The script may also be ordered in chronological order based on the time each statement was made. In some embodiments, the script may additionally include images generated from the content associated with a presenter. For example, where a presenter is sharing a slide presentation, the images may be generated based on each new slide presented to the conference. As another example, where a presenter is sharing a document, images may be generated based on any substantial change in the view of the document, such as scrolling to a different page or tab in a document. Events, such as users joining or leaving a conference, conference roster updates, users initiating votes or question/answer sessions (and their results), etc., may also be indicated on the script at the time in which they took place.

In this way, the web conference script may look much like a script for a play or film, and may aid in allowing users to obtain the relevant information from web conferences in a short amount of time. In addition, the web conference script may be stored, for example, in a database of web conference scripts to allow users to search for web conferences that may be relevant to their interests. Thus, while the user may not otherwise know of a conference, he or she may be able to access its content through a search and may be able to contact one or more people participating in the conference for further details if necessary.

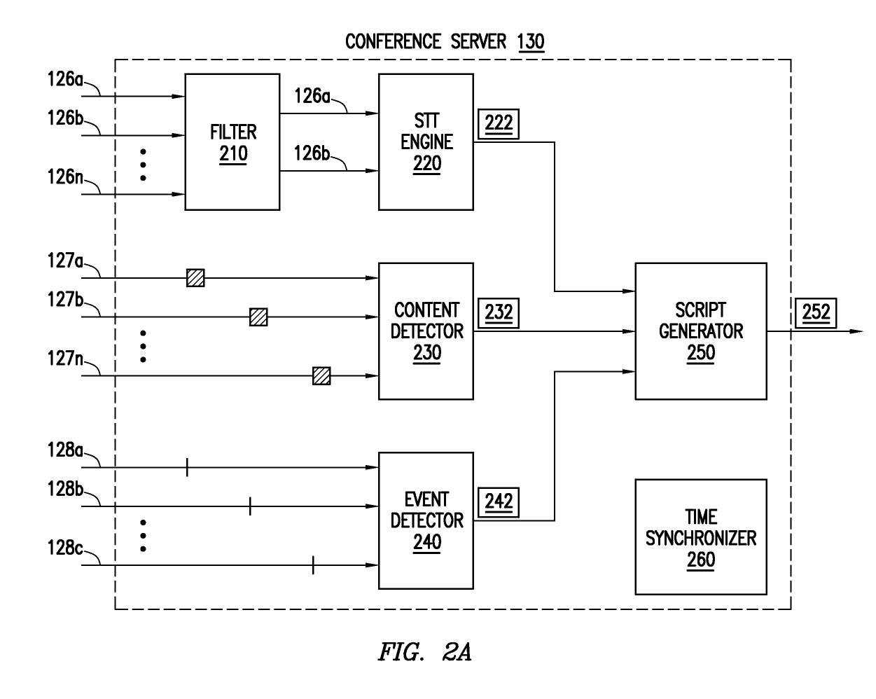

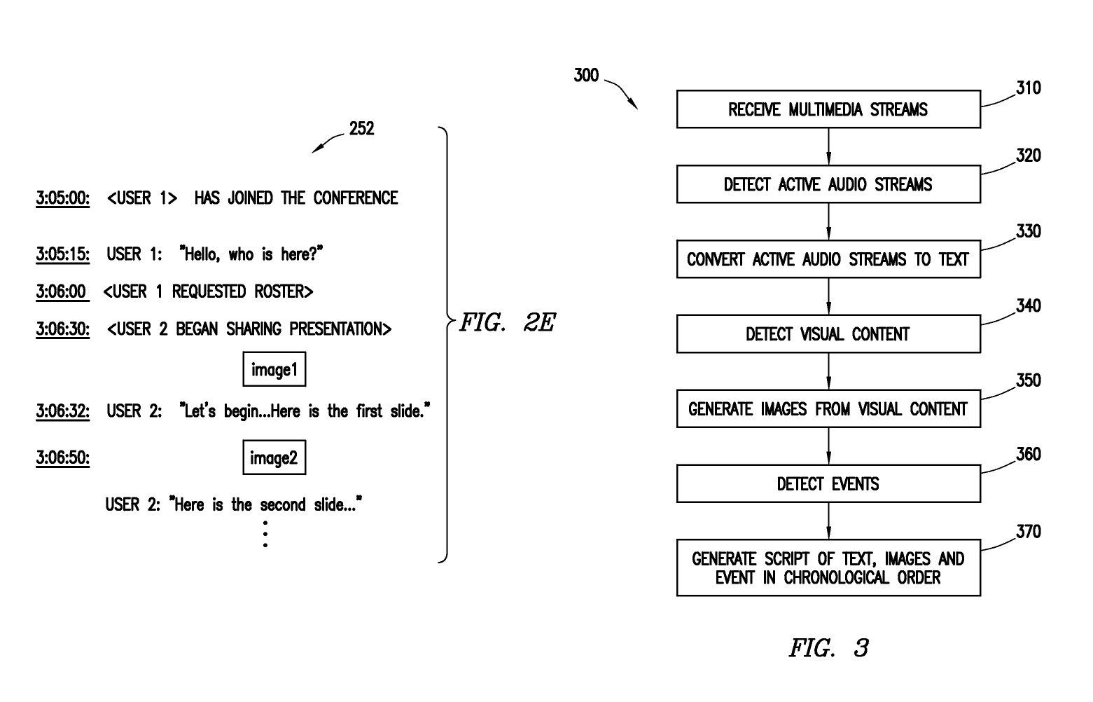

FIG. 2A illustrates an example conference server 130 of system 100 of FIG. 1 according to particular embodiments of the present disclosure. FIG. 2A may represent a functional block diagram of conference server 130 (in contrast to FIG. 4 below, which may represent a specific architecture of conference server 130). During a web conference, conference server 130 may receive audio streams 126 from nodes 120 or telephones 121. Conference server 130 may then determine which of the audio streams 126 are active audio streams by passing each through a filter 210. Filter 210 may determine active audio streams based on a relative volume of each audio stream 126 compared to a certain threshold. In some embodiments, filter 210 may only select a predetermined number of active audio streams to pass on in order to conserve bandwidth and/or processing capacity at conference server 130 (e.g. by comparing each audio stream to the other conference participants' audio streams). Thus, if three people are speaking at once (i.e. there are three active audio streams), filter 210 may only select two active audio streams to proceed to speech-to-text engine 220. Speech-to-text engine 220 may then convert the selected active audio streams 126 to text using any suitable speech-to-text method and generate audio table 222.

Conference server 130 may also receive content 127 from nodes 120 during a web conference at content detector 230. Content 127 may include, for example, images of documents being shared by a presenter (e.g. slide presentations), video from an active speaker of a video conference, etc. Content detector 230 may generate images of content 127 at predetermined intervals of time or based on changes detected in content 127. For example, during a slide presentation, content detector 230 may determine the changes in slides being presented and generate images at each slide change. As another example, content detector 230 may determine that a document has been scrolled substantially and may generate an image at the end of the scrolling. Content detector 230 may then generate content table 232 accordingly.

Conference server 130 may also receive events 128 from nodes 120 during a web conference at event detector 240. Events 128 may include, for example, indications of users joining or leaving a conference, conference roster updates, initiations of voting or question/answer sessions, or any other suitable conference event. Based on these events, event detector 240 may generate event table 242.

Conference server may additionally include a script generator 250, which may generate a web conference script 252 based on the information contained in audio table 222, content table 232, and event table 242. For example, the script 252 may include the text of active audio streams generated by speech-to-text engine 22, with indications of who was speaking and at what time. In addition, the script 252 may include the images generated by content detector 230 inserted at the relative time at which the image was generated. The script 252 may also include indications of the events detected by event detector 240 inserted at the relative time at which they were detected. In some embodiments, script 252 may be sent to each of the nodes 120 participating in the web conference. In some embodiments, script 252 may be stored at conference server 130 (or another database) for archival purposes and for future access, for example by users searching for web conference information related to a particular subject of interest.

Conference server may additionally include a time synchronizer 260 that is operable to synchronize the time among all nodes 120 participating in a web conference. In particular embodiments, each node 120 may include an instance of a time synchronizer that communicates with time synchronizer 260 at conference server 130 in order to synchronize times. In certain embodiments, when there is a conflict of time between a node 120 and conference sever 130, the time at conference server 130 may be used as the reference for synchronization.

FIG. 2B illustrates an example audio table 222 of conference server 130 of FIG. 2A according to particular embodiments of the present disclosure. Audio table 222 may include records for each active audio stream detected by conference server 130. For example, audio table 222 may include an identifier for each active audio stream 126, a start time for each active audio stream 126, an end time for each active audio stream 126, a user associated with each active audio stream 126, and the text generated by speech-to-text engine 220 for each active audio stream 126, as shown in FIG. 2B. Audio table 222 may be stored in a database associated with conference server 130, or may be partially or fully distributed among nodes 120 participating in a conference. For example, in some embodiments, audio table 222 may be stored in a database table associated with conference server 130 and may include records for all nodes 120 participating in a web conference. In other embodiments, audio tables 222 may be distributed among nodes 120 participating in a web conference, which may serve to conserve resources at conference server 130. For example, an audio table 222 may be stored at a node 120 participating in a web conference may store records for the active audio streams associated with that particular node 120. In some embodiments including distributed audio tables 222, each node 120 may store an audio table 222 associated with its respective active audio streams. In other embodiments including distributed audio tables 222, only some nodes 120 participating in a web conference may store an audio table 222 associated with its respective active audio streams, while other audio tables 222 are stored in a database associated with conference server 130. In embodiments including distributed audio tables 222, speech-to-text engine 220 may be located on the node associated with the audio table, and each audio table may be subsequently sent to conference server 130 for storage and/or script generation.

FIG. 2C illustrates an example content table 232 of conference server 130 of FIG. 2A according to particular embodiments of the present disclosure. Content table 232 may include records for content 127 shared by nodes 120 participating in a web conference. For example, content table may include an identifier for each content 127 generated during a web conference, a time when each content 127 was shared, a user associated with each content 127 being shared, and an image associated with each content 127, the image being generated by content detector 230, as shown in FIG. 2C. As with audio table 222, content table 232 may be stored in a database associated with conference server 130, or may be partially or fully distributed among nodes 120 participating in a conference. For example, in some embodiments, content table 232 may be stored in a database table associated with conference server 130 and may include records for all nodes 120 participating in a web conference. In other embodiments, content tables 232 may be distributed among nodes 120 participating in a web conference, which may serve to conserve resources at conference server 130. For example, an content table 232 may be stored at a node 120 participating in a web conference may store records for the active audio streams associated with that particular node 120. In some embodiments including distributed content tables 232, each node 120 may store an content table 232 associated with its respective active audio streams. In other embodiments including distributed content tables 232, only some nodes 120 participating in a web conference may store an content table 232 associated with its respective active audio streams, while other content tables 232 are stored in a database associated with conference server 130. In embodiments including distributed content tables 232, content detector 230 may be located on the node associated with the content table, and each content table may be subsequently sent to conference server 130 for storage and/or script generation.

FIG. 2D illustrates an example event table 242 of conference server 130 of FIG. 2A according to particular embodiments of the present disclosure. Event table 242 may include records for events 128 associated with nodes 120 participating in a web conference. For example, event table 242 may include an identifier for each event 128, a time associated with each event 128, a user associated with each event 128, and a description of each event 128, as shown in FIG. 2D. In particular embodiments, event table 242 may be stored in a database associated with conference server 130 and may be used for script generation. In other embodiments, event table 242 may be stored at a node 120 and may sent to conference server 130 for storage and/or script generation.

FIG. 2E illustrates an example script 252 of a web conference produced by conference server 130 of FIG. 2A according to particular embodiments of the present disclosure. Script 252 may be generated by script generator 250 at conference server 130 and may contain a written record of a web conference. The record may include one or more parts compiled from audio table(s) 222, content table(s) 232, and/or event table 242. For example, in some embodiments, script 252 may include a text translation of each active audio stream 126 and an indication of the particular user associated with each active audio stream 126. In some embodiments, the text translations may be ordered according to times associated with the respective corresponding active audio stream (e.g., chronologically). This information may be gathered from audio table 222. Script 252 may additionally include, for each text translation, an indication of the time associated with the corresponding active audio stream, such as a start time of audio table 222. Script 252 may also include images, such as images of content table 232, generated based on content 127 being shared by various nodes 120 during a web conference. In some embodiments, script 252 may also include indications of events 128 associated with various nodes 120 during a web conference. Theses indications may be derived from event table 242.

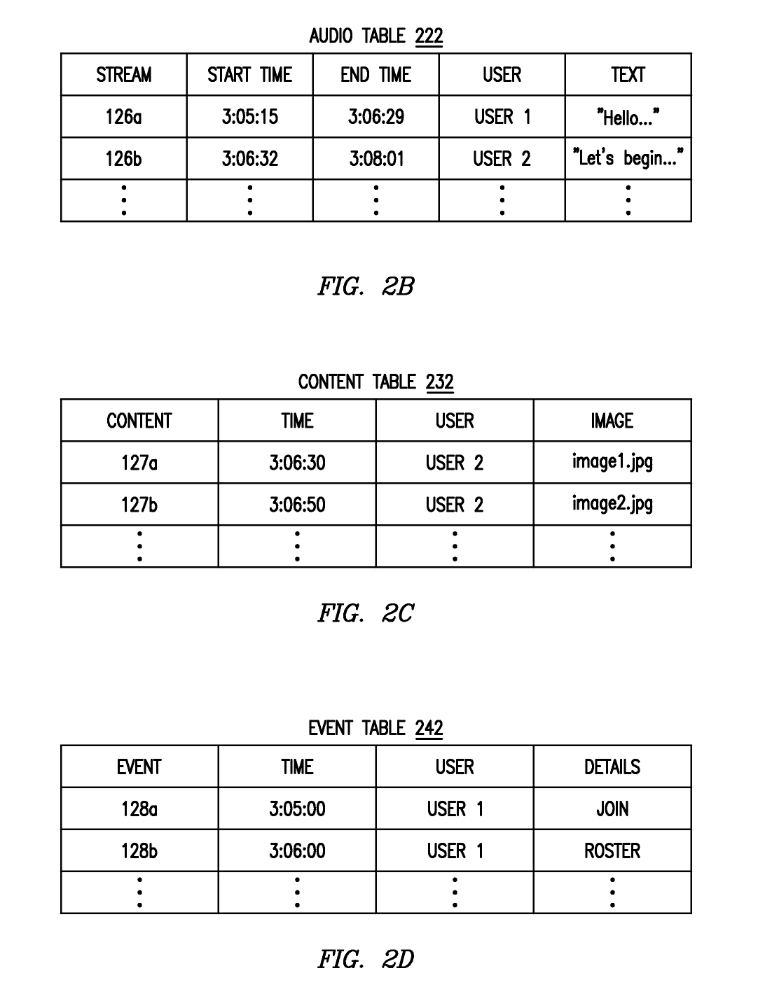

FIG. 3 illustrates and example method 300 for generating a script of a web conference, such as script 252 of FIG. 2E, using conference server 130 of FIG. 1 according to particular embodiments of the present disclosure. The method 300 begins at step 310, where conference server 130 receives a plurality of multimedia streams 125 from nodes participating in a web conference. Conference server 130 then detects active audio streams 126 in multimedia streams 125 at step 320. Active audio streams 126 may be detected, for example, based on volume thresholds. Alternatively, active audio streams 126 may be detected based on a comparison of relative volumes of audio streams in multimedia streams 125. In some embodiments, active audio streams 126 may be filtered prior to being passed on for further processing. In this way, only a subset of active audio streams 126 may be passed on for further processing. The filtering may be performed, for example, by filter 210 on conference server 130.

At step 330, the active audio streams are converted to text. This may be done using any suitable method of speech-to-text conversion, and may be performed, for example, by a speech-to-text engine residing on conference server 130 or a node 120. At step 340, conference server 130 detects visual content 127 in multimedia streams 125. The visual content may include slide presentations, desktop sharing, still images, video, etc. being shared by one or more nodes 120 participating in the web conference. Conference server 130 may then generate images from the visual content 127. The images may be snapshots of the visual content 127. For example, the images for a slide presentation may be each of the slides presented. As another example, the images for a video being shared may be snapshots of the video at various points in time. At step 360, conference server 130 detects events 128 associated with one or more nodes 120. The events may include, for example, indications of users joining or leaving a conference, conference roster updates, initiations of voting or question/answer sessions, or any other suitable conference event.

After detecting active audio streams 126, visual content 127, and events 128, conference server 130 may then generate script 252 at step 370. Script 252 may include a text translation of each active audio stream 126 and an indication of the particular user associated with each active audio stream 126. In some embodiments, the text translations may be ordered according to times associated with the respective corresponding active audio stream (e.g., chronologically). Script 252 may additionally include, for each text translation, an indication of the time associated with the corresponding active audio stream. Script 252 may also include images generated based on the visual content 127 detected by conference server 130. In some embodiments, script 252 may also include indications of events 128 detected by conference server 130.

FIG. 4 illustrates an example architecture of conference server 130 of FIG. 1 that may be used in accordance with particular embodiments. Conference server 130 may include its own respective processor 411, memory 413, instructions 414, storage 415, interface 417, and bus 412. In particular embodiments, nodes 120 may include components similar to those of conference server 130. These components may work together to perform one or more steps of one or more methods (e.g. the method of FIG. 3) and provide the functionality described herein. For example, in particular embodiments, instructions 414 in memory 413 may be executed on processor 411 in order to generate a script for a web conference based on multimedia streams received by interface 417. In certain embodiments, instructions 414 may reside in storage 415 instead of, or in addition to, memory 413.

Processor 411 may be a microprocessor, controller, application specific integrated circuit (ASIC), or any other suitable computing device operable to provide, either alone or in conjunction with other components (e.g., memory 413 and instructions 414) script generation functionality. Such functionality may include detecting active audio streams, content, and/or events in multimedia streams, as discussed herein. In particular embodiments, processor 411 may include hardware for executing instructions 414, such as those making up a computer program or application. As an example and not by way of limitation, to execute instructions 414, processor 411 may retrieve (or fetch) instructions 414 from an internal register, an internal cache, memory 413 or storage 415; decode and execute them; and then write one or more results to an internal register, an internal cache, memory 413, or storage 415.

Memory 413 may be any form of volatile or non-volatile memory including, without limitation, magnetic media, optical media, random access memory (RAM), read-only memory (ROM), flash memory, removable media, or any other suitable local or remote memory component or components. Memory 413 may store any suitable data or information utilized by conference server 130, including software (e.g., instructions 414) embedded in a computer readable medium, and/or encoded logic incorporated in hardware or otherwise stored (e.g., firmware). In particular embodiments, memory 413 may include main memory for storing instructions 414 for processor 411 to execute or data for processor 411 to operate on. In particular embodiments, one or more memory management units (MMUs) may reside between processor 411 and memory 413 and facilitate accesses to memory 413 requested by processor 411.

Storage 415 may include mass storage for data or instructions (e.g., instructions 414). As an example and not by way of limitation, storage 415 may include a hard disk drive (HDD), a floppy disk drive, flash memory, an optical disc, a magneto-optical disc, magnetic tape, a Universal Serial Bus (USB) drive, a combination of two or more of these, or any suitable computer readable medium. Storage 415 may include removable or non-removable (or fixed) media, where appropriate. Storage 415 may be internal or external to conference server 130 (and/or remote transceiver 220), where appropriate. In some embodiments, instructions 414 may be encoded in storage 415 in addition to, in lieu of, memory 413.

Interface 417 may include hardware, encoded software, or both providing one or more interfaces for communication (such as, for example, packet-based communication) between conference server 130 and any other computer systems on network 110. As an example, and not by way of limitation, interface 417 may include a network interface controller (NIC) or network adapter for communicating with an Ethernet or other wire-based network and/or a wireless NIC (WNIC) or wireless adapter for communicating with a wireless network. Interface 417 may include one or more connectors for communicating traffic (e.g., IP packets) via a bridge card. Depending on the embodiment, interface 417 may be any type of interface suitable for any type of network in which conference server 130 is used. In some embodiments, interface 417 may include one or more interfaces for one or more I/O devices. One or more of these I/O devices may enable communication between a person and conference server 130. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these.

Bus 412 may include any combination of hardware, software embedded in a computer readable medium, and/or encoded logic incorporated in hardware or otherwise stored (e.g., firmware) to couple components of conference server 130 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 412 may include any number, type, and/or configuration of buses 412, where appropriate. In particular embodiments, one or more buses 412 (which may each include an address bus and a data bus) may couple processor 411 to memory 413. Bus 412 may include one or more memory buses.

Although various implementations and features are discussed with respect to multiple embodiments, it should be understood that such implementations and features may be combined in various embodiments. For example, features and functionality discussed with respect to a particular figure, such as FIG. 4, may be used in connection with features and functionality discussed with respect to another such figure, such as FIGS. 2-3, according to operational needs or desires.

Numerous other changes, substitutions, variations, alterations and modifications may be ascertained by those skilled in the art and it is intended that particular embodiments encompass all such changes, substitutions, variations, alterations and modifications as falling within the spirit and scope of the appended claims.

What is claimed is:

1. A system, comprising:
an interface operable to detect a plurality of active audio streams in a plurality of multimedia streams, each multimedia stream associated with a particular user;
a processor operable to:
generate a text translation of each active audio stream; and
generate a script comprising the text translation of each active audio stream and an indication of the particular user associated with each active audio stream, the text translations being ordered according to times associated with the respective corresponding active audio stream.

2. The system of claim 1, wherein the script further comprises, for each text translation, an indication of the time associated with the corresponding active audio stream.

3. The system of claim 1, wherein the processor is further operable to detect an event associated with a stream of the plurality of multimedia streams, and wherein the script further comprises an indication of the event and the particular user associated with the stream.

4. The system of claim 3, wherein the processor is further operable to receive one or more responses associated with the event, and wherein the script further comprises an indication of the one or more responses received.

5. The system of claim 1, wherein the processor is further operable to:
detect visual content associated with a stream of the plurality of multimedia streams; and
generate a first image based on the visual content; and
wherein the script further comprises the first image.

6. The system of claim 5, wherein the processor is further operable to generate a second image based on the visual content, and wherein the script further comprises the first image.

7. The system of claim 1, wherein the processor is further operable to filter the plurality of active audio streams based on audio levels of the active audio streams.

8. A method, comprising:
detecting a plurality of active audio streams in a plurality of multimedia streams, each multimedia stream associated with a particular user;
generating a text translation of each active audio stream; and
generating, by a computer, a script comprising the text translation of each active audio stream and an indication of the particular user associated with each active audio stream, the text translations being ordered according to times associated with the respective corresponding active audio stream.

9. The method of claim 8, wherein the script further comprises, for each text translation, an indication of the time associated with the corresponding active audio stream.

10. The method of claim 8, further comprising detecting an event associated with a stream of the plurality of multimedia streams, wherein the script further comprises an indication of the event and the particular user associated with the stream.

11. The method of claim 10, further comprising receiving one or more responses associated with the event, wherein the script further comprises an indication of the one or more responses received.

12. The method of claim 8, further comprising:
detecting visual content associated with a stream of the plurality of multimedia streams; and
generating a first image based on the visual content; and
wherein the script further comprises the first image.

13. The method of claim 12, further comprising generating a second image based on the visual content, wherein the script further comprises the first image.

14. The method of claim 8, further comprising filtering the plurality of active audio streams based on audio levels of the active audio streams.

15. A computer readable medium comprising instructions operable, when executed by a processor, to:
detect a plurality of active audio streams in a plurality of multimedia streams, each multimedia stream associated with a particular user;
generate a text translation of each active audio stream; and
generate a script comprising the text translation of each active audio stream and an indication of the particular user associated with each active audio stream, the text translations being ordered according to times associated with the respective corresponding active audio stream.

16. The computer readable medium of claim 15, wherein the script further comprises, for each text translation, an indication of the time associated with the corresponding active audio stream.

17. The computer readable medium of claim 15, wherein the instructions are further operable to detect an event associated with a stream of the plurality of multimedia streams, and wherein the script further comprises an indication of the event and the particular user associated with the stream.

18. The computer readable medium of claim 17, wherein the instructions are further operable to receive one or more responses associated with the event, and wherein the script further comprises an indication of the one or more responses received.

19. The computer readable medium of claim 15, wherein the instructions are further operable to:
detect visual content associated with a stream of the plurality of multimedia streams; and
generate a first image based on the visual content; and
wherein the script further comprises the first image.

20. The computer readable medium of claim 19, wherein the instructions are further operable to generate a second image based on the visual content, and wherein the script further comprises the first image.

21. The computer readable medium of claim 15, wherein the instructions are further operable to filter the plurality of active audio streams based on audio levels of the active audio streams.
